(19) United States
(12) Patent Application Publication
(10) Pub. No.: US 2021/0179039 A1
(43) Pub. Date: Jun. 17, 2021

(54) BRAKING ASSISTANCE APPARATUS FOR A VEHICLE

(71) Applicant: TOYOTA JIDOSHA KABUSHIKI KAISHA, Toyota-shi (JP)

(72) Inventors: Mafune KAKESHITA, Toyota-shi (JP); Toshifumi Kawasaki, Toyota-shi (JP)

(73) Assignee: TOYOTA JIDOSHA KABUSHIKI KAISHA, Toyota-shi (JP)

(21) Appl. No.: 17/116,112

(22) Filed: Dec. 9, 2020

(30) Foreign Application Priority Data
Dec. 11, 2019 (JP) 2019-223895

(51) Int. Cl. B60T 7/22; B60T 8/171; B60T 8/172; B60T 8/58

(52) U.S. Cl. CPC B60T 7/22; B60T 8/171; B60T 8/172; B60T 2201/03; B60T 2220/04; B60T 2210/32; B60T 2201/022; B60T 8/58

(57) ABSTRACT

A braking assistance apparatus for a vehicle that calculates a first target deceleration of a host vehicle for avoiding a collision based on a relative distance and a relative speed between an obstacle and the host vehicle, calculates a second target deceleration of the host vehicle based on an assist level indicating the risk of the host vehicle colliding with the obstacle and a master cylinder pressure that is a braking operation related quantity, calculates a final target deceleration on the basis of a weighted sum of the target decelerations in which a weight of larger one of the target decelerations is set larger than the other weight so as not to exceed the larger one of the target decelerations, and performs braking assistance by controlling the braking device so that a deceleration of the host vehicle becomes the final target deceleration.

### CROSS-REFERENCE TO RELATED APPLICATION

This application claims priority to Japanese Patent Application No. JP2019-223895 filed on Dec. 11, 2019, the content of which is hereby incorporated by reference in its entirety into this application.

### BACKGROUND

### 1. Technical Field

The present disclosure relates to a braking assistance apparatus for a vehicle such as an automobile.

### 2. Description of the Related Art

As a collision prevention apparatus for a vehicle such as an automobile, a braking assistance apparatus for applying a braking force to a vehicle is known in which, when an obstacle is detected in front of a host vehicle, a collision risk level at which the host vehicle collides with the obstacle is determined, and braking assistance control is performed when the collision risk level is high. In order to prevent the host vehicle from colliding with an obstacle, a braking force for braking assistance needs to be increased as the collision risk level is higher and as a braking operation amount of a driver is smaller.

For example, in Japanese Patent Application Laid-open Publication No. 2015-81075, there is described a braking assistance apparatus configured to calculate a threshold value that is smaller as a collision risk revel is higher, when a braking operation amount of a driver is equal to or more than the threshold value, calculate a braking assistance amount such that a ratio of the braking assistance amount to the braking operation amount of the driver is increased as the collision risk revel is higher, and generate a braking force corresponding to a sum of the braking operation amount of the driver and the braking assistance amount.

According to the braking assistance apparatus described in the above Publication, a braking force corresponding to the sum of the braking operation amount of the driver and the braking assistance amount is generated, and the braking assistance amount is increased such that the ratio of the braking assistance amount to the braking operation amount of the driver is increased as the collision risk revel is higher. Therefore, the higher the collision risk revel of the host vehicle colliding with an obstacle, the higher the braking force for braking assistance can be applied to the vehicle, so that the collision of the host vehicle with the obstacle can be effectively prevented as compared to where, for example, the braking force for braking assistance is constant.

However, in the braking assistance apparatus described in the above Publication, a braking force for the braking assistance is calculated to increase as a collision risk revel increases without considering a braking operation amount of the driver. Accordingly, in a situation where the collision risk revel is high and the braking force for the braking assistance is calculated to be a high value, and a braking operation amount of the driver is also large, it is inevitable that the driver feels uncomfortable because the braking force becomes excessive and a deceleration of the vehicle becomes excessive when a braking force corresponding to the sum of the braking operation amount of the driver and the braking assistance amount is generated.

If a braking force for the braking assistance is calculated to be smaller in order to avoid excessive deceleration of the vehicle due to excessive braking force, a braking force corresponding to the sum of the braking operation amount of the driver and the braking assistance amount is smaller and a deceleration of the vehicle is also smaller, so that the host vehicle cannot be effectively prevented from colliding with an obstacle.

### SUMMARY

The present disclosure provides a braking assistance apparatus improved so as to prevent a host vehicle from colliding with an obstacle by applying a braking force for braking assistance to the host vehicle while preventing the braking force for the braking assistance from becoming excessive.

According to the present disclosure, a braking assistance apparatus for a vehicle is provided which has an obstacle information acquisition device configured to acquire information on a relative distance and a relative speed between an obstacle in front of a host vehicle and the host vehicle, a braking operation related quantity acquisition device configured to acquire a braking operation related quantity of a driver, and an electronic control unit for controlling a braking device of the host vehicle.

The control unit is configured to:

calculate a first target deceleration of the host vehicle for avoiding the host vehicle colliding with an obstacle based on the relative distance and the relative speed between the obstacle and the host vehicle acquired by the obstacle information acquisition device;

calculate, based on the relative distance and the relative speed, an assist level that increases as the risk of the host vehicle colliding with the obstacle increases;

calculate a second target deceleration of the host vehicle based on the assist level and the braking operation related quantity acquired by the braking operation related quantity acquisition device so that the second target deceleration increases as the assist level increases and as the braking operation related quantity increases;

set weights such that the weight of larger one of the first and second target decelerations is larger than the weight of smaller one of the first and second target decelerations;

calculate a final target deceleration of the host vehicle based on a weighted sum of the first and second target decelerations so as not to exceed the larger one of the first and second target decelerations; and

perform braking assistance by controlling the braking device so that a deceleration of the host vehicle becomes the final target deceleration.

According to the above configuration, a first target deceleration of the host vehicle for avoiding a collision is calculated based on a relative distance and a relative speed between the obstacle and the host vehicle, and a second target deceleration of the host vehicle is calculated based on an assist level and a braking operation related quantity. In addition, weights of the first and second target decelerations are set such that the weight of larger one of the first and second target decelerations is larger than the weight of smaller one of the first and second target decelerations; a final target deceleration of the host vehicle is calculated based on a weighted sum of the first and second target decelerations so as not to exceed the larger one of the first and second target decelerations; and the braking device is controlled so that a deceleration of the host vehicle becomes the final target deceleration.

Therefore, since the final target deceleration does not become larger than the larger one of the first and second target decelerations, it is possible to prevent the final target deceleration from becoming an excessively large deceleration. In addition, since weights of the first and second target decelerations are set such that the weight of the larger one of the first and second target decelerations is larger than the weight of the smaller one of the first and second target decelerations, the final target deceleration can be calculated so that the larger one of the first and second target decelerations is preferentially reflected. Therefore, the final target deceleration can be prevented from becoming an excessively small deceleration.

Furthermore, even if one of the first and second target decelerations sharply decreases to be smaller than the other of the first and second target decelerations, the final target deceleration does not decrease sharply, which enables to reduce the possibility that an occupant or occupants of the vehicle feels uncomfortable.

In one aspect of the present disclosure, the electronic control unit is configured to set the weights of the larger and smaller ones of the first and second target decelerations to 1 and 0, respectively.

According to the above aspect, the final target deceleration can be set to the larger one of the first and second target decelerations. Therefore, the final target deceleration can be prevented from becoming an excessively large deceleration, and the deceleration of the vehicle can be controlled based on the larger one of the first and second target decelerations. Thus, even if one of the first and second target decelerations sharply decreases to be smaller than the other of the first and second target decelerations, the final target deceleration can effectively be prevented from sharply decreasing, which enables to effectively reduce the possibility that the occupant or occupants of the vehicle feels uncomfortable due to the decrease in the deceleration of the vehicle.

In another aspect of the present disclosure, the electronic control unit is configured to limit the second target deceleration by an upper limit value that increases as the assist level increases.

According to the above aspect, the second target deceleration is limited by an upper limit value that increases as the assist level increases. Therefore, as compared to where the second target deceleration is not limited by the upper limit value, the possibility that the second target deceleration is calculated to be an excessively large value is reduced, which enables to reduce effectively the risk that the final target deceleration is calculated to be extremely large and the deceleration of the vehicle becomes excessive.

Furthermore, the upper limit value is variably set according to the assist level so that the higher the assist level, the larger the upper limit value. Therefore, as compared to where the upper limit value is constant, in a situation where the assist level is low, the possibility that the limit of the second target deceleration by the upper limit value can be reduced, and in a situation where the assist level is high, the possibility that the second target deceleration is excessively limited by the upper limit value is insufficient can be reduced.

Other objects, other features and attendant advantages of the present disclosure will be readily understood from the description of the embodiments of the present disclosure described with reference to the following drawings.

### BRIEF DESCRIPTION OF THE DRAWINGS

FIG. 1 is a schematic configuration diagram showing a first embodiment of a vehicle braking assistance apparatus for a vehicle according to the present disclosure.

FIG. 2 is a flowchart showing a main routine of braking assistance control in the first embodiment.

FIG. 3 is a flowchart showing a subroutine executed in step 60 of the flowchart shown in FIG. 2, that is, a routine for calculating a target deceleration Gbt of the vehicle for braking assistance.

FIG. 4 is a flowchart showing a latter half of a routine for calculating a target deceleration Gbt of the vehicle in the second embodiment.

FIG. 5 is a map for calculating an assist level AL based on a collision margin time TTC.

FIG. 6 is a time chart for explaining a specific example of an operation of the braking assistance apparatus described in the above-mentioned Japanese Patent Application Laid-open Publication.

FIG. 7 is a time chart for explaining a specific example of an operation of the second embodiment.

FIG. 8 is a map for calculating an increase correction coefficient K based on a collision margin time TTC in a second modified example.

FIG. 9 is a map for calculating an upper limit value Gbtguard of a second target deceleration Gbt2 based on a collision margin time TTC in a third modified example.

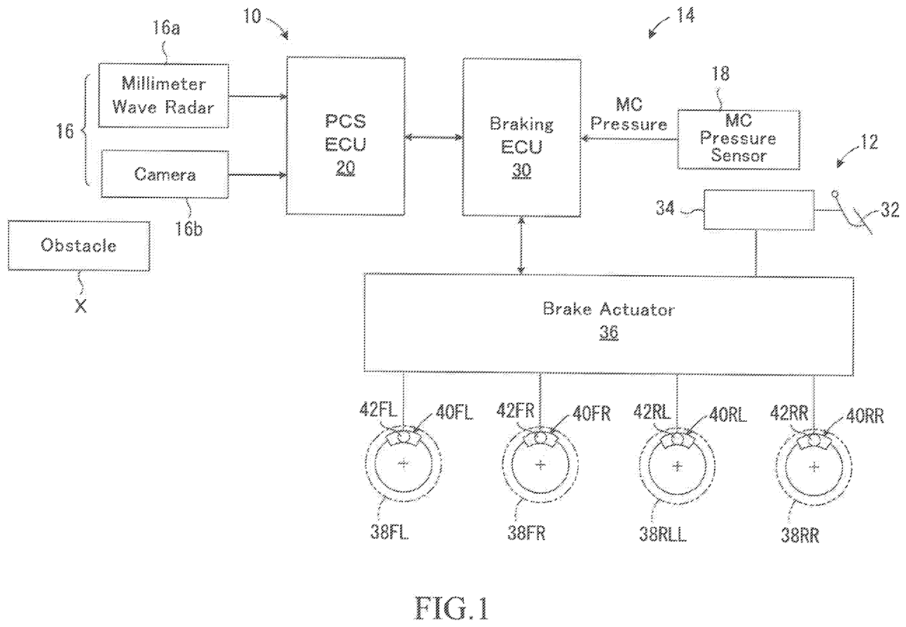

### DETAILED DESCRIPTION

The present disclosure will now be described in detail with reference to the accompanying drawings.

### First Embodiment

The braking assistance apparatus 10 according to the first embodiment is applied to a vehicle (host vehicle) 14 including a braking device 12, and performs braking assistance by intervention in order to prevent the host vehicle from colliding with an obstacle X. It is to be noted that the vehicle 14 may be any vehicle, for example, a vehicle having an engine as a driving force source, a hybrid vehicle, or an electric vehicle having only an electric motor or motors as a driving force source or sources.

The braking assistance apparatus 10 includes an obstacle information acquisition device 16, a master cylinder pressure (referred to as “MC pressure”) sensor 18 that functions as a braking operation related quantity acquisition device, a collision prevention (pre-crash safety) electronic control unit 20, and a braking electronic control unit 30. As will be described in detail later, the collision prevention electronic control unit 20 and the braking electronic control unit 30 function as control units that cooperate with each other to control the braking device 12 when executing the braking assistance. The collision prevention electronic control unit is abbreviated as PCS ECU, and the braking electronic control unit is abbreviated as braking ECU.

The obstacle information acquisition device 16 detects an obstacle X (including another vehicle) in front of the host vehicle, and detects a relative distance and a relative speed between the host vehicle and the obstacle, and an azimuth of the obstacle relative to the host vehicle. In the embodiment, the obstacle information acquisition device 16 includes a millimeter wave radar 16a and a camera 16b, but the obstacle detection may be performed only by the millimeter wave radar 16a. A laser radar or the like may be used instead of the millimeter wave radar 16a.

The millimeter-wave radar 16a detects an obstacle by transmitting a millimeter-wave band (for example, 60 GHz) radio wave forward and receiving a wave reflected by the obstacle X, thereby detecting a relative distance between the host vehicle and the obstacle, a relative speed between them and an azimuth of the obstacle. The millimeter wave radar 16a outputs information about the relative distance and relative speed between the host vehicle and the obstacle and the azimuth of the obstacle to the PCS ECU 20.

The camera 16b is an imaging device that images the front of the vehicle. The camera 16b includes, for example, a pair of left and right imaging elements, and may be configured to detect a relative distance and a relative speed between the host vehicle and the obstacle based on the images captured by the imaging elements. The camera 16b outputs information about the relative distance and the relative speed between the host vehicle and the obstacle to the PCS ECU 20. Notably, an arithmetic processing unit that calculates a relative distance and a relative speed between the host vehicle and the obstacle based on an image captured by the camera 16b may be included in the camera 16b, or may be included in the PCS ECU 20 that receives an image information.

The braking device 12 includes a master cylinder device 34 driven by a brake pedal 32 being depressed by a driver, a brake actuator 36, and braking force generation devices 40FL, 40FR, 40RL and 40RR provided on left and right front wheels 38FL and 38FR and left and right rear wheels 38RL and 38RR, respectively. As is well known, the braking force generation devices 40FL to 40RR increase or decrease braking forces of the corresponding wheels by increasing or decreasing pressures in wheel cylinders 42FL to 42RR, respectively, by the brake actuator 36.

The brake actuator 36 includes a hydraulic circuit, which is not shown in the figure, including a pump that generates high pressure, various valve devices, and the like. The brake actuator 36 normally controls the pressures in the wheel cylinders 42FL to 42RR in accordance with a pressure in the master cylinder device 34, that is, an MC pressure Pmc, thereby controlling braking forces of the wheels 38FL to 38RR according to an amount of braking operation by the driver. Further, the brake actuator 36 can individually control the pressures in the wheel cylinders 42FL to 42RR without depending on the MC pressure, and thereby individually controls the braking forces of the wheels 38FL to 38RR regardless of the braking operation amount of the driver.

The MC pressure sensor 18 is a device that detects an MC pressure Pmc as a braking operation related quantity in order to detect a braking operation amount and a braking operation speed of the driver. Since the MC pressure is generated in proportion to a braking operation amount of the driver (a pedal effort applied to the brake pedal 32), the braking operation amount can be detected by detecting the MC pressure, and a braking operation speed can be obtained by differentiating the MC pressure with respect to time. The MC pressure sensor 18 outputs information about the MC pressure to the braking ECU 30. A braking operation amount of the driver may be detected by another device such as a pedal effort sensor provided on the brake pedal 32, and the braking operation speed may be obtained as a time differential value of the braking operation amount detected by the pedal effort sensor.

The PCS ECU 20 and the braking ECU 30 each include a microcomputer, and each microcomputer includes a CPU that performs arithmetic processing, a ROM that stores a control program, a readable/writable RAM that stores arithmetic results, a timer, a counter, an input interface and an output interface. The PCS ECU 20 and the braking ECU 30 may be any arithmetic control device known in the art. Further, some of the functions of the PCS ECU 20 and the braking ECU 30 may be realized by another ECU. Further, some of the functions of the PCS ECU 20 and the braking ECU 30 may be realized by the other ECU.

The PCS ECU 20 loads a control program stored in the ROM into the CPU and executes the control program to execute processes such as calculation of a collision margin time TTC which will be described later, setting of an assist level AL, requests to the braking ECU 30 and a meter ECU (not shown). The PCS ECU 20 is communicatively connected to the obstacle information acquisition device 16 (the millimeter wave radar 16a and the camera 16b), the braking ECU 30, and the like by an in-vehicle LAN such as a CAN (Controller Area Network) or a harness.

The PCS ECU 20 receives obstacle information output from the millimeter wave radar 16a and the camera 16b, and obtains a relative distance Dr and a relative speed Vr of the host vehicle 14 relative to an obstacle X in front of the host vehicle 14 and an azimuth of the obstacle. A collision margin time TTC (Time To Collision) is calculated based on the relative distance, the relative speed, and the azimuth. The collision margin time TTC is a value obtained by dividing the relative distance Dr between the host vehicle and the obstacle by the relative speed Vr, and is a time until the host vehicle collides with the obstacle. The smaller the collision margin time TTC, the higher the risk of the host vehicle colliding with the obstacle. Therefore, the collision margin time TTC is also a collision risk level indicating a risk of the host vehicle colliding with the obstacle.

The relative distance between the host vehicle and the obstacle used when calculating the collision margin time TTC may be a distance detected by the millimeter wave radar 16a, or a distance detected by the camera 16b, and it may be an average value of the distance detected by the millimeter wave radar 16a and the distance detected by the camera 16b. The relative distance and the relative speed between the host vehicle and the obstacle used when calculating the collision margin time TTC may be corrected to be a relative distance and a relative speed in the traveling direction of the host vehicle using the information on the azimuth of the obstacle detected by the millimeter wave radar 16a.

The PCS ECU 20 sets an assist level AL as a collision risk level according to the calculated collision margin time TTC. The assist level AL is set in four stages of 0 to 3 according to the map shown in FIG. 5, for example. As shown in FIG. 5, the assist level AL increases as the collision allowance time TTC decreases, and thus the collision risk level increases as the assist level AL progresses from 0 to 3. The PCS ECU 20 outputs a signal indicating the assist level AL to the braking ECU 30.

For example, when the assist level AL is 0, it is considered that the possibility of collision is low, and the braking assistance (brake assist) controlled by the braking ECU 30 described later is not performed, and the braking assistance may be performed when the assist level AL is 1 to 3. Therefore, when the assist level AL is 1 to 3, the PCS ECU 20 requests the braking ECU 30 to perform the braking assistance.

Furthermore, the PCS ECU 20 may perform driving assistance according to the assist level AL via a meter ECU (not shown) or the like. The meter ECU may be connected to a combination meter device (not shown) for notifying the driver by display, a notification sound generating device (not shown) for notifying the driver by voice, and the like. The meter ECU may control, in response to a request from the PCS ECU 20, numerical values, characters, figures, indicator lamps, etc. displayed on the combination meter device, and also may control alarm sound and alarm voice notified by the notification sound generating device. For example, when the assist level AL is 1 to 3, the PCS ECU 20 may request the meter ECU to output an alarm sound for informing the driver of the possibility of a collision or turn on an indicator lamp.

The braking ECU 30 loads a control program stored in the ROM into the CPU and executes the control program to execute various processes relating to the braking assistance described later. Further, the braking ECU 30 is communicatively connected to the MC pressure sensor 18, the PCS ECU 20, the brake actuator 36, and the like through an in-vehicle LAN such as CAN or a harness.

The braking ECU 30 controls the braking forces of the wheels 38FL to 38RR generated by the braking force generation devices 40FL to 40RR by controlling the brake actuator 36. Particularly, when the assist level AL is 0, the braking ECU 30 controls the brake actuator 36 so as to control the braking forces in a normal manner. That is, the braking ECU 30 controls the brake actuator 36 to control the pressures in the wheel cylinders 42FL to 42RR according to the MC pressure Pmc so that the braking forces of the wheels 38FL to 38RR are controlled according to an amount of braking operation by the driver, and controls the brake actuator 36 so that the pressures are individually controlled as necessary regardless of the amount of braking operation by the driver.

On the other hand, when the assist level AL is 1 to 3, the braking ECU 30 controls the brake actuator 36 so that the braking assistance for preventing the collision of the vehicle is performed. Specifically, the braking ECU 30 performs the braking assistance when it can be determined that an emergency brake operation is performed by the driver based on the brake operation amount and the brake operation speed. The braking assistance is achieved by controlling the brake actuator 36 so that the deceleration of the vehicle becomes higher than the deceleration corresponding to the braking operation of the driver, and thus the pressures in the wheel cylinders 42FL to 42RR become higher than the MC pressure Pmc. In a hybrid vehicle or an electric vehicle, regenerative braking may be performed on the basis of a request from the PCS ECU 20 also in braking assistance.

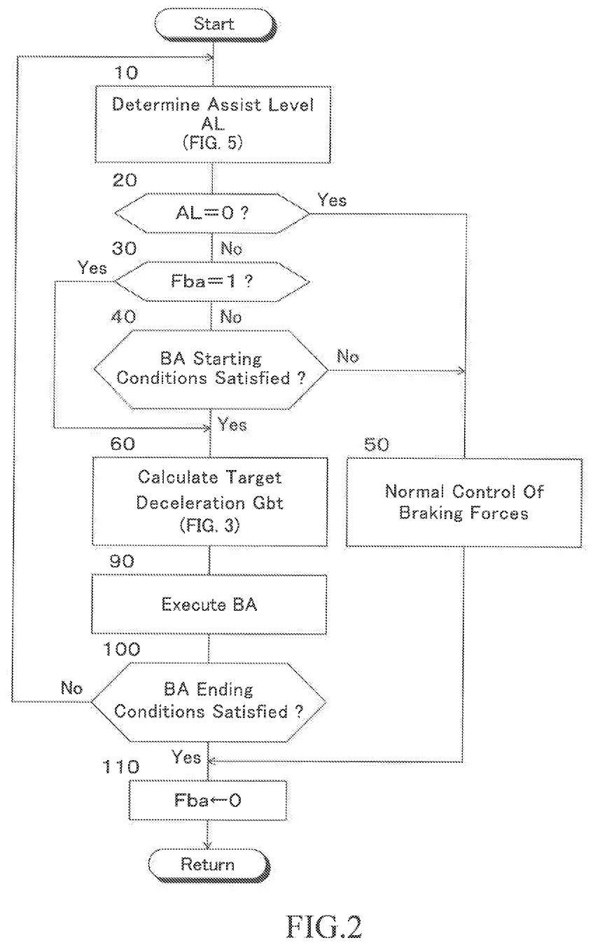

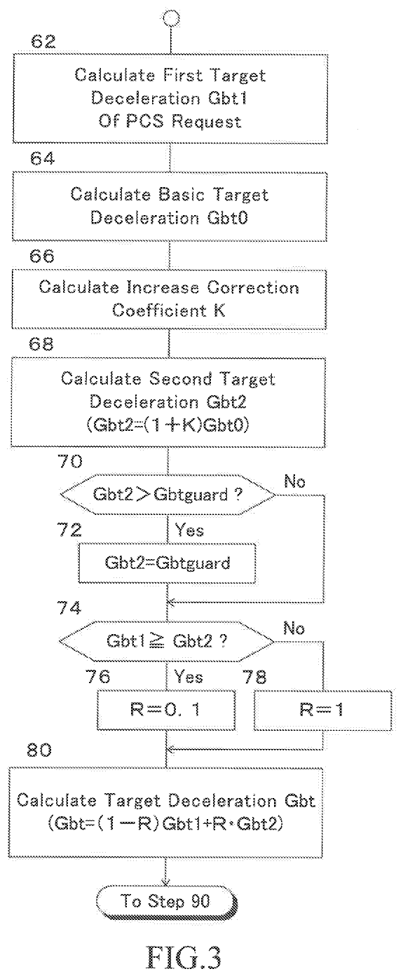

In the first embodiment, the braking assistance is executed according to the flowcharts shown in FIGS. 2 and 3. A first target deceleration Gbt1 of a PCS request is calculated based on the relative distance and the relative speed between the host vehicle and the obstacle, and a second target deceleration Gbt2 is calculated so that the higher the MC pressure Pmc and the collision risk of collision with the obstacle, the higher the second target deceleration. Further, the target deceleration Gbt of the vehicle for the braking assistance is calculated as a weighted sum of the first target deceleration Gbt1 and the second target deceleration Gbt2. A weight R is set so that a weight of the larger one of the first target deceleration Gbt1 and the second target deceleration Gbt2 is greater.

### <Braking Assistance Control in the First Embodiment>

FIG. 2 is a flowchart showing a main routine of braking assistance control for collision prevention in the first embodiment, and the braking assistance control is achieved by the cooperation of the PCS ECU 20 and the braking ECU 30. The braking assistance control according to the flowchart shown in FIG. 2 is repeatedly executed at predetermined time intervals when an ignition switch (not shown) is ON. In the following description, the braking assistance control according to the flowchart shown in FIG. 2 will be simply referred to as “the control”. In addition, in FIG. 2, the braking assistance is described as BA.

First, in step 10, a collision margin time TTC is calculated based on a relative distance Dr and a relative speed Vr between the host vehicle and the obstacle, and an azimuth of the obstacle, and an assist level AL is determined by referring to the map shown in FIG. 5 based on the collision margin time TTC. The assist level AL is an index value indicating a degree of need for the braking assistance, and as shown in FIG. 5, the assist level AL increases as the collision margin time TTC decreases.

Prior to step 10, signals indicating the presence or absence of an obstacle X around the vehicle detected by the obstacle information acquisition device 16, a relative distance Dr between the vehicle and the obstacle, a relative speed Vr, and an azimuth of the obstacle are read. Further, a signal indicating an MC pressure Pmc detected by the MC pressure sensor 18 is read.

In step 20, a determination is made as to whether or not the assist level AL is 0, that is, whether or not the braking assistance for collision prevention is unnecessary. When an affirmative determination is made, the control proceeds to step 50, and when a negative determination is made, the control proceeds to step 30.

In step 30, a determination is made as to whether a flag Fba is 1, that is, whether the braking assistance is being executed. When an affirmative determination is made, the control proceeds to step 60, and when a negative determination is made, the control proceeds to step 40.

In step 40, a determination is made as to whether or not conditions for starting the braking assistance are satisfied. When an affirmative determination is made, the control proceeds to step 60, and when a negative determination is made, the control proceeds to step 50.

It should be noted that when the MC pressure Pmc is equal to or higher than a reference value Pmcc and a change rate Pmcd of the MC pressure is equal to or higher than a reference value Pmcdc, it may be determined that the conditions for starting the braking assistance are satisfied. As shown in Table 1 below, the reference values Pmcc and Pmcd are variably set according to the assist level AL. The reference values Pmcc1 to Pmcc3 are positive constants having a relationship of Pmcc1>Pmcc2>Pmcc3, and the reference values Pmcdc1 to Pmcdc3 are positive constants having a relationship of Pmcdc1>Pmcdc2>Pmcdc3. Therefore, the reference values Pmcc and Pmcdc are variably set according to the assist level AL so that the higher the assist level AL, the smaller the reference values Pmcc and Pmcdc.

TABLE 1

| Assist Level | Reference | Reference |
|---|---|---|
| AL | Value Pmcc | Value Pmcdc |
| 1 | Pmcc1 | Pmcdc1 |
| 2 | Pmcc2 | Pmcdc2 |
| 3 | Pmcc3 | Pmcdc3 |

In step 50, the normal control of the braking forces without the braking assistance is executed. That is, by controlling the pressures in the wheel cylinders 42FL to 42RR according to the MC pressure Pmc, the braking forces of the wheels 38FL to 38RR are controlled according to the braking operation amount of the driver.

In step 60, a target deceleration Gbt of the vehicle for the braking assistance is calculated as described later according to the subroutine shown in FIG. 3.

In step 90, target braking forces Fbtfl to Fbtrr of the wheels 38FL to 38RR are calculated based on the target deceleration Gbt in a manner known in the art. Further, by controlling the brake actuator 36 so that the braking forces of the wheels 38FL to 38RR become the target braking forces Fbtfl to Fbtrr, respectively, the pressures of the wheel cylinders 42FL to 42RR are controlled, and thereby the braking assistance is executed.

In step 100, a determination is made as to whether or not a condition for ending the braking assistance is satisfied. When a negative determination is made, the control returns to step 10, and when an affirmative determination is made, the flag Fba is reset to 0 in step 110, and then the control returns to step 10.

It should be noted that when any one of the following conditions is satisfied, it may be determined that the condition for ending the braking assistance is satisfied.

(1) The MC pressure Pmc is less than or equal to an end reference value Pmce (a positive constant).
(2) The vehicle speed is below an end reference value (a positive constant).
(3) An equipment necessary for executing the braking assistance, such as the obstacle information acquisition device 16, is abnormal.
(4) A time more than an end reference time (a positive constant) has elapsed since the application of braking forces by executing the braking assistance was started.

As shown in FIG. 3, the calculation of the target deceleration Gbt of the vehicle in the above step 60 is performed by executing the following steps 62 to 80.

In step 62, a first target deceleration Gbt1 of a PCS (pre-crash safety) request is calculated based on the relative distance Dr and the relative speed Vr between the host vehicle and the obstacle detected by the obstacle information acquisition device 16. For example, if a target relative distance when the vehicle is stopped by braking is represented by Drt and an elapsed time is represented by t, the following equations (1) and (2) are established. Therefore, the first target deceleration Gbt1 may be calculated according to the following equation (3). It is to be noted that an azimuth of the obstacle may be considered when the first target deceleration Gbt1 is calculated.

Drt=Dr−Gbt1·t²/2 (1)

Dr−Drt=Vr·t (2)

Gbt1=Vr²/{2(Dr−Drt)} (3)

In step 64, a basic target deceleration Gbt0 based on the MC pressure Pmc is calculated to a value proportional to the MC pressure Pmc. That is, the basic target deceleration Gbt0 is calculated according to the MC pressure Pmc so that the higher the MC pressure, the larger the target deceleration.

In step 66, as shown in Table 2 below, an increase correction coefficient K for the basic target deceleration Gbt0 is calculated based on the assist level AL. In Table 2, K1, K2 and K3 are positive constants having a relationship of K1<K2<K3. Therefore, the increase correction coefficient K is variably set according to the assist level AL such that the increase correction coefficient K has a larger value as the assist level AL is higher.

TABLE 2

| Assist Level | Increase Correction |
|---|---|
| AL | Coefficient K |
| 1 | K1 |
| 2 | K2 |
| 3 | K3 |

In step 68, a second target deceleration Gbt2 based on the MC pressure Pmc and the assist level AL is calculated based on the increase correction coefficient K and the basic target deceleration Gbt0 according to the following equation (4). Therefore, the second target deceleration Gbt2 is calculated so that the higher the assist level AL, the larger the target deceleration, and the higher the MC pressure Pmc, the larger the target deceleration.

Gbt2=(1+K)Gbt0 (4)

In step 70, an upper limit value Gbtguard of the second target deceleration Gbt2 is calculated based on the assist level AL so that the higher the assist level AL is, the larger the upper limit value Gbtguard is. Further, a determination is made as to whether or not the second target deceleration Gbt2 is larger than the upper limit value Gbtguard. When a negative determination is made, the control proceeds to step 74. When an affirmative determination is made, the second target deceleration Gbt2 is corrected to the upper limit Gbtguard in step 72, and then the control proceeds to step 74.

In step 74, a determination is made as to whether or not the first target deceleration Gbt1 is greater than or equal to the second target deceleration Gbt2. When an affirmative determination is made, a weight R of the second target deceleration is set to 0.1 in step 76, and then the control proceeds to step 80. On the other hand, when a negative determination is made, the weight R is set to 1 in step 78, and then the control proceeds to step 80.

It is to be noted that the weight R set in step 76 may be greater than 0 and smaller than 0.5 because the weight 1-R of the first target deceleration Gbt1 needs to be greater than the weight R of the second target deceleration Gbt2. However, the greater the weight R, the lower the degree of reflection of the first target deceleration Gbt1 on the target deceleration Gbt so that the weight R is preferably a value close to 0, for example, a value larger than 0 and smaller than 0.15.

In step 80, a target deceleration (final target deceleration) Gbt of the vehicle for the braking assistance is calculated as a weighted sum of the first target deceleration Gbt1 and the second target deceleration Gbt2 according to the following equation (5).

Gbt=(1−R)Gbt1+R·Gbt2 (5)

### <Operation of the First Embodiment>

Next, the operation of the first embodiment will be described for a case where the braking assistance is unnecessary and a case where the braking assistance is required. The operation in the case where the braking assistance is unnecessary is the same in the second embodiment described later.

### <When the Braking Assistance is not Required>

When the braking assistance is unnecessary because the possibility of collision is low, the assist level AL is determined to be 0 in step 10, and an affirmative determination is made in step 20. Further, even though there is a possibility of collision, when the conditions for staring the braking assistance are not satisfied and thus the braking assistance is not required, negative determinations are made in steps 20 and 40. Therefore, in step 50, the normal braking force control is performed without executing the braking assistance for collision prevention.

### <When the Braking Assistance is Required>

When there is a possibility of collision and the braking assistance is required, in step 10, the assist level AL is determined to be one of 1-3, and in step 20, a negative determination is made. Step 30 or steps 30 and 40 are executed, and step 60, and thus steps 62 to 80, are executed.

In step 62, a first target deceleration Gbt1 of the PCS request is calculated based on the relative distance and the relative speed between the host vehicle and the obstacle. In steps 64 to 72, a second target deceleration Gbt2 based on the MC pressure Pmc and the assist level AL is calculated so that the higher the MC pressure Pmc and the assist level AL, the higher the second target deceleration Gbt2 but does not exceed the upper limit value Gbtguard. Further, in steps 74 to 80, a target deceleration Gbt of the vehicle for the braking assistance is calculated as a weighted sum of the first target deceleration Gbt1 and the second target deceleration Gbt2. In this case, when the first target deceleration Gbt1 is greater than or equal to the second target deceleration Gbt2, the weight R is set to 0.1, and when the first target deceleration Gbt1 is smaller than the second target deceleration Gbt2, the weight R is set to 1.

According to the first embodiment, the first target deceleration Gbt1 of the host vehicle for avoiding a collision is calculated based on the relative distance Dr and the relative speed Vr between the obstacle and the host vehicle 14. The second target deceleration Gbt2 of the host vehicle is calculated based on the assist level AL and the MC pressure Pmc which is a braking operation related quantity. In addition, the weights 1-R and R of the first and second target decelerations, respectively, are set so that the weight of the larger one of the first and second target deceleration is greater than that of the smaller one. Further, the final target deceleration Gbt of the host vehicle is calculated according to the equation (5) as a weighted sum of the first and second target decelerations calculated so as not to exceed the larger one of the first and second target decelerations. The braking device 12 is controlled so that a deceleration Gb of the host vehicle becomes the final target deceleration Gbt.

Therefore, the final target deceleration Gbt never becomes larger than the larger one of the first target deceleration Gbt1 and the second target deceleration Gbt2, so that it is possible to prevent the final target deceleration from becoming an excessively large deceleration. In addition, the weights are set so that the weight of the larger one of the first and second target decelerations is greater than the other weight, so that the final target deceleration can be calculated by preferentially reflecting the larger one of the first and second target decelerations. Therefore, it is possible to prevent the final target deceleration from becoming an excessively small deceleration, that is, it can be prevented that the collision of the vehicle cannot be effectively prevented.

Furthermore, even if one of the first and second target decelerations sharply decreases, the final target deceleration does not decrease sharply, so that it is possible to reduce the possibility that an occupant or occupants of the vehicle feels uncomfortable.

### Second Embodiment

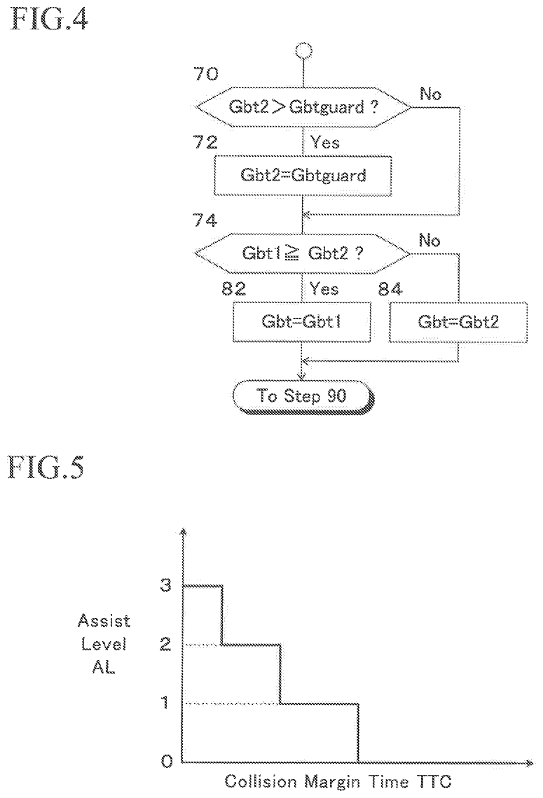

The braking assistance apparatus 10 of the second embodiment is configured similarly to the braking assistance apparatus of the first embodiment, and the braking assistance control of the second embodiment is the same as that of the first embodiment except step 60. Step 60 in the second embodiment is executed according to the subroutine shown in FIG. 4, thereby a target deceleration Gbt of the vehicle for the braking assistance is calculated.

Although steps 62-68 are not shown in FIG. 4, steps 62-74 are performed similarly to steps 62-74 in the first embodiment. When an affirmative determination is made in step 74, the target deceleration (final target deceleration) Gbt of the vehicle for the braking assistance is set to the first target deceleration Gbt1 in step 82, and then the control proceeds to step 90. On the other hand, when a negative determination is made in step 74, the target deceleration Gbt of the vehicle is set to the second target deceleration Gbt2 in step 84, and then the control proceeds to step 90.

As can be seen from the comparison between FIG. 3 and FIG. 4, setting the target deceleration Gbt of the vehicle in the second embodiment is the same as executing the step 80 by setting the weight R to 0 in the step 76 in the first embodiment. Therefore, the target deceleration Gbt of the vehicle is set to the value of the larger one of the first target deceleration Gbt1 and the second target deceleration Gbt2.

<Operation of the Second Embodiment when the Braking Assistance is Required>

The target deceleration Gbt of the vehicle for the braking assistance is set to the first target deceleration Gbt1 when the first target deceleration Gbt1 is equal to or greater than the second target deceleration Gbt2, and is set to the second target deceleration Gbt2 when the first target deceleration Gbt1 is smaller than the second target deceleration Gbt2. The other operations are the same as those in the first embodiment.

According to the second embodiment, the final target deceleration Gbt can be set to the value of the larger one of the first target deceleration Gbt1 and the second target deceleration Gbt2. Therefore, the final target deceleration can be prevented from becoming an excessively large deceleration, and a deceleration Gb of the vehicle can be controlled based on the value of the larger one of the first and second target decelerations. Thus, even if one of the first and second target decelerations sharply decreases, the final target deceleration Gbt can effectively be prevented from sharply decreasing, so that it is possible to effectively reduce the possibility that an occupant or occupants of the vehicle feels uncomfortable due to the sudden decrease.

It is to be noted that according to the first and second embodiments, the second target deceleration Gbt2 is limited by an upper limit value Gbtguard calculated based on the assist level AL. Therefore, as compared to where the second target deceleration Gbt2 is not limited by the upper limit value Gbtguard, the possibility that the second target deceleration is calculated to be an excessively large value is reduced, and thus, it is possible to effectively reduce the risk that the final target deceleration Gbt is calculated to be an excessively large deceleration and the vehicle deceleration Gb becomes excessive.

Further, the upper limit value Gbtguard is variably set according to the assist level AL such that the upper limit value Gbtguard increases as the assist level AL increases. Therefore, as compared to where the upper limit value Gbtguard is constant, in a situation where the assist level AL is low, it is possible to reduce the possibility that the second target deceleration Gbt2 is insufficiently limited by the upper limit value, and in a situation where the assist level AL is high, it is possible to reduce the possibility that the second target deceleration Gbt2 is excessively limited by the upper limit value.

### <Specific Example of the Operation of the Second Embodiment>

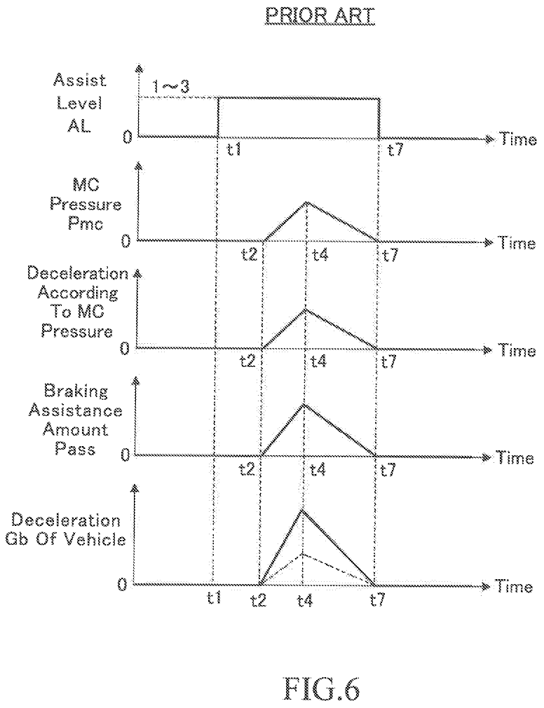

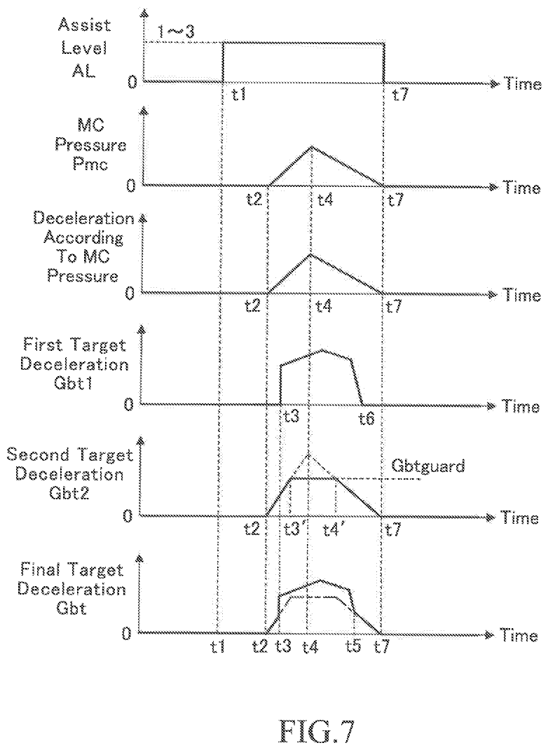

Next, referring to FIGS. 6 and 7, a specific example (FIG. 7) of the operation of the second embodiment will be described in comparison with a specific example (FIG. 6) of the operation of the braking assistance device described in Japanese Patent Application Laid-open Publication No. 2015-81075 described above.

As shown in FIG. 6, it is assumed that the assist level AL becomes a value other than 0 from time t1 to time t7, and a driver performs a braking operation from time t2 to time t7, whereby the MC pressure Pmc increases from 0 at time t2 to the maximum value at time t4 and gradually decreases to 0 at time t7.

A braking assistance amount Pass corresponding to the MC pressure Pmc increases/decreases in accordance with the increase/decrease in the MC pressure Pmc. Therefore, a deceleration Gb of the vehicle when the braking assistance is performed becomes a value corresponding to the sum Pmc+Pass of the MC pressure Pmc and the braking assistance amount Pass.

Therefore, when an amount of braking operation by the driver is high and the MC pressure Pmc has a high value, the braking assistance amount Pass also has a high value, and as a result, an occupant or occupants of the vehicle may feel uncomfortable due to the cause that the deceleration Gb of the vehicle becomes excessive at, for example, time t4 and before and after that.

On the other hand, according to the second embodiment, since the final target deceleration Gbt is set to the value of the larger one of the first target deceleration Gbt1 and the second target deceleration Gbt2, the final target deceleration does not become an excessively large deceleration. Therefore, it is possible to prevent the occupant or occupants of the vehicle from feeling uncomfortable due to the excessive deceleration Gb of the vehicle.

For example, as shown in FIG. 7, it is assumed that the assist level AL and the MC pressure Pmc change as in FIG. 6. It is also assumed that the first target deceleration Gbt1 of the PCS request occurs from time t3 to time t6 and increases and decreases as shown in the figure. It is also assumed that the second target deceleration Gbt2 based on the MC pressure Pmc and the assist level AL gradually increases from 0 at time t2 and then gradually decreases to 0 at time t7, and is corrected to the upper limit value Gbtguard from time t3′ to time t4′. Further, it is assumed that the first target deceleration Gbt1 becomes smaller than the second target deceleration Gbt2 at time t5 immediately before the time t6.

Since the target deceleration (final target deceleration) Gbt of the vehicle is set to the value of the larger one of the first target deceleration Gbt1 and the second target deceleration Gbt2, it changes as shown at the bottom of FIG. 7. That is, the target deceleration Gbt is the second target deceleration Gbt2 in the sections from the time t2 to the time t3 and from the time t5 to the time t7, and is the first target deceleration Gbt1 in the section from the time t3 to the time t5.

Therefore, since the target deceleration Gbt is not set to the sum of the first target deceleration Gbt1 and the second target deceleration Gbt2, it does not become an excessive value even when the MC pressure Pmc has a high value. In particular, the second target deceleration Gbt2 is corrected to the upper limit value Gbtguard when it exceeds the upper limit value. Therefore, even when the MC pressure Pmc is high and the second target deceleration Gbt2 is high, the target deceleration Gbt can be reliably prevented from becoming excessive.

Further, the target deceleration Gbt is set to the second target deceleration Gbt2 in the sections from the time t2 to the time t3 and from the time t6 to the time t7 where the first target deceleration Gbt1 is 0. Therefore, it is possible to prevent the occupant or occupants of the vehicle from feeling uncomfortable due to insufficient deceleration of the vehicle in these sections.

Although the present disclosure has been described in detail with reference to specific embodiments, it will be apparent to those skilled in the art that the present disclosure is not limited to the above-described embodiments, and various other embodiments are possible within the scope of the present disclosure.

For example, in the above-described first and second embodiments, in step 66, the increase correction coefficient K is set so that the higher the assist level AL is, the larger the correction value K is set, and in step 68, the second target deceleration Gbt2 is calculated as a product of the coefficient (1+K) and the basic target deceleration Gbt0.

However, as shown in Table 3 below, a braking assistance amount ΔGbt2 of the deceleration may be calculated such that the higher the assist level AL, the larger the braking assistance amount, and the second target deceleration Gbt2 may be calculated as a sum of the basic target deceleration Gbt0 and the braking assistance amount ΔGbt2 (a first modified example). In Table 3, ΔGbt21, ΔGbt22, and ΔGbt23 are positive constants having a relationship of ΔGbt21<ΔGbt22<ΔGbt23.

TABLE 3

| Assist Level | Braking Assistance |
|---|---|
| AL | Aamount Δ Gbt2 |
| 1 | Δ Gbt21 |
| 2 | Δ Gbt22 |
| 3 | Δ Gbt23 |

Further, in the above-described first and second embodiments, the increase correction coefficient K is set to three levels so that the higher the assist level AL is, the larger the correction value K becomes, and the second target deceleration Gbt2 is calculated as a product of the increase correction coefficient 1+K and the basic target deceleration Gbt0. Therefore, when the assist level AL changes stepwise with the increase or decrease of the collision margin time TTC, the second target deceleration Gbt2 also changes stepwise.

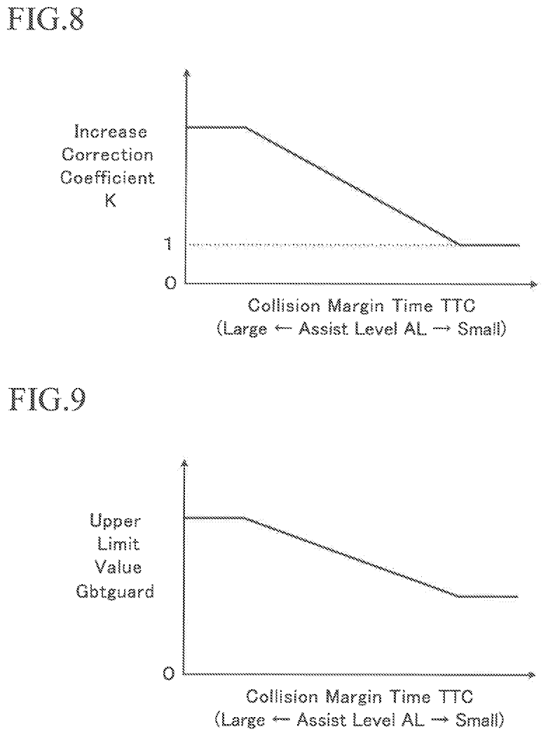

Therefore, the increase correction coefficient K may be calculated by referring to, for example, the map shown in FIG. 8 so that the smaller the collision margin time TTC is, that is, the higher the assist level AL is, the larger the correction coefficient K is, whereby the second target deceleration Gbt2 may be continuously changed as the collision margin time TTC is increased and decreased (a second modified example).

Similarly, in the first and second embodiments described above, in step 70, the upper limit value Gbtguard of the second target deceleration Gbt2 is calculated based on the assist level AL so that the higher the assist level AL is, the larger the upper limit value is. Therefore, when the assist level AL changes stepwise as the collision margin time TTC increases and decreases, the upper limit value Gbtguard also changes stepwise.

Therefore, the upper limit value Gbtguard may be calculated by referring to, for example, the map shown in FIG. 9 so that it continuously increases as the collision margin time TTC decreases, that is, as the assist level AL increases, whereby, the upper limit value Gbtguard may be continuously changed as the collision margin time TTC is increased and decreased (a third modification example).

Although in the first and second embodiments described above, braking operation related quantity indicating a braking operation amount of a driver is an MC pressure Pmc, it may be a brake pedal effort or a brake pedal stroke or any combination of an MC pressure, a brake pedal effort and a brake pedal stroke.

What is claimed is:

1. A braking assistance apparatus for a vehicle having an obstacle information acquisition device configured to acquire information on a relative distance and a relative speed between an obstacle in front of a host vehicle and the host vehicle, a braking operation related quantity acquisition device configured to acquire a braking operation related quantity of a driver, and an electronic control unit for controlling a braking device of the host vehicle, wherein
the electronic control unit is configured to:
calculate a first target deceleration of the host vehicle for avoiding the host vehicle colliding with an obstacle based on the relative distance and the relative speed between the obstacle and the host vehicle acquired by the obstacle information acquisition device;
calculate, based on the relative distance and the relative speed, an assist level that increases as the risk of the host vehicle colliding with the obstacle increases;
calculate a second target deceleration of the host vehicle based on the assist level and the braking operation related quantity acquired by the braking operation related quantity acquisition device so that the second target deceleration increases as the assist level increases and as the braking operation related quantity increases;
set weights such that the weight of larger one of the first and second target decelerations is larger than the weight of smaller one of the first and second target decelerations;
calculate a final target deceleration of the host vehicle based on a weighted sum of the first and second target decelerations so as not to exceed the larger one of the first and second target decelerations; and perform braking assistance by controlling the braking device so that a deceleration of the host vehicle becomes the final target deceleration.

2. The braking assistance apparatus for a vehicle according to claim 1, wherein the electronic control unit is configured to set the weights of the larger and smaller ones of the first and second target decelerations to 1 and 0, respectively.

3. The braking assistance apparatus for a vehicle according to claim 1, wherein the electronic control unit is configured to limit the second target deceleration by an upper limit value that increases as the assist level increases.
